(19) United States
(12) Patent Application Publication
(10) Pub. No.: US 2003/0233562 A1
(43) Pub. Date: Dec. 18, 2003

(54) Data-protection circuit and method

(76) Inventors: Sachin Chheda, Roseville, CA (US); Dhruv Choksey, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/171,371

(22) Filed: Jun. 12, 2002

(51) Int. Cl. G06F 12/14

(52) U.S. Cl. 713/193

(57) ABSTRACT

A data-protection circuit selectively allows access to data stored in a memory. Specifically, the circuit receives an authorization key and allows access to the data if the authorization key equals a predetermined value. Such a circuit can be used to prevent an unauthorized agent such as an unauthorized update package, a virus, or a hacker from reading or corrupting data such as firmware because the agent presumably will not have or be able to obtain the authorization key. Furthermore, by disposing the data-protection circuit and memory on separate integrated circuits (ICs), one can implement data protection without altering the design of the memory IC. This allows one to implement data protection for off-the-shelf memory ICs that include no integrated protection circuit. For example, one can implement the data-protection circuit in a field-programmable gate array (FPGA) that is coupled to but separate from the memory IC.

### BACKGROUND OF THE INVENTION

An unauthorized agent such as an unauthorized software-update package, a computer “virus”, or “hacker” can wreak havoc on a computer system. An authorized software-update package is software, typically from the computer manufacturer or from an authorized third-party support service, that upgrades the computer's functionality. But a system administrator, however well meaning, may upgrade the computer's software with an unauthorized update package to customize the computer. Unfortunately, such an unauthorized upgrade may have unanticipated and undesirable consequences such as file corruption or erosion of data security. A virus is a piece of software code that causes an “infected” computer system to perform an undesired or destructive task such as to delete electronic files to which the system has access. A virus typically spreads by causing an infected computer system to replicate the virus, attach the replications to emails, and send the emails to the addresses that are stored on the system. When a recipient of such an email opens the virus attachment—the virus attachment is usually disguised as a legitimate attachment—the virus infects the recipient's computer system. A virus can also spread by embedding itself in an electronic file. When a recipient transfers the file to his computer system via, e.g., a floppy disk or CD-ROM, and opens the infected file, the virus infects the system. A hacker is an individual who gains unauthorized access to a computer system, and typically causes the system to perform undesired tasks or otherwise corrupts the system.

Referring to FIG. 1, which is a block diagram of a computer circuit 10, one way that an unauthorized agent corrupts a computer system is by altering the system's firmware. The circuit 10 belongs to a computer system (not shown in FIG. 1) and includes a processor 12, a memory 14, an address bus 16, a data bus 18, and a read/write line 20. The memory 14 stores the firmware that the processor 12 executes during “boot” of the computer system, i.e., before the operating system is loaded into working memory (not shown). The firmware causes the processor 12 to perform tasks such as configuring the processor and peripheral hardware (not shown) and loading the operating system. Once the computer system is fully booted, an authorized agent such as a manufacturer's firmware-update package can upgrade the firmware by writing new firmware code to the locations (not shown) of the memory 14 where the firmware is stored. Unfortunately, when an unauthorized agent infiltrates the computer system, it may alter the firmware in an undesired manner. Consequently, during a subsequent boot of the computer system, the processor 12 will execute the undesirably altered firmware, which will typically cause the processor to perform one or more undesired tasks or operate in an undesired manner as discussed above.

### SUMMARY OF THE INVENTION

In one aspect of the invention, a data-protection circuit selectively allows access to data stored in a memory location. Specifically, the circuit receives an authorization key and allows access to the data only if the authorization key equals a predetermined value. To allow protection of a memory location of an integrated circuit (IC) that has no protection circuitry, the data-protection circuit may be disposed on a separate IC.

Such a circuit can be used to prevent an unauthorized agent from reading or altering data such as firmware because the agent presumably will not have or be able to obtain the authorization key. Furthermore, by disposing the data-protection circuit on an IC that is separate from the memory IC, one can implement data protection without altering the design of the memory IC. This allows one to implement data protection for off-the-shelf memory ICs that include no integrated protection circuitry. For example, one can implement the data-protection circuit in a field-programmable gate array (FPGA) that is coupled to but separate from the memory IC.

### BRIEF DESCRIPTION OF THE DRAWINGS

FIG. 1 is a schematic block diagram of a conventional computer circuit.

FIG. 2 is a schematic block diagram of a computer circuit that includes a data-protection circuit according to an embodiment of the invention.

FIG. 3 is a schematic block diagram of the data-protection circuit of FIG. 2 according to an embodiment of the invention.

FIG. 4 is a schematic block diagram of an electronic computer system that incorporates the computer circuit of FIG. 2 according to an embodiment of the invention.

### DESCRIPTION OF THE PREFERRED EMBODIMENTS

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

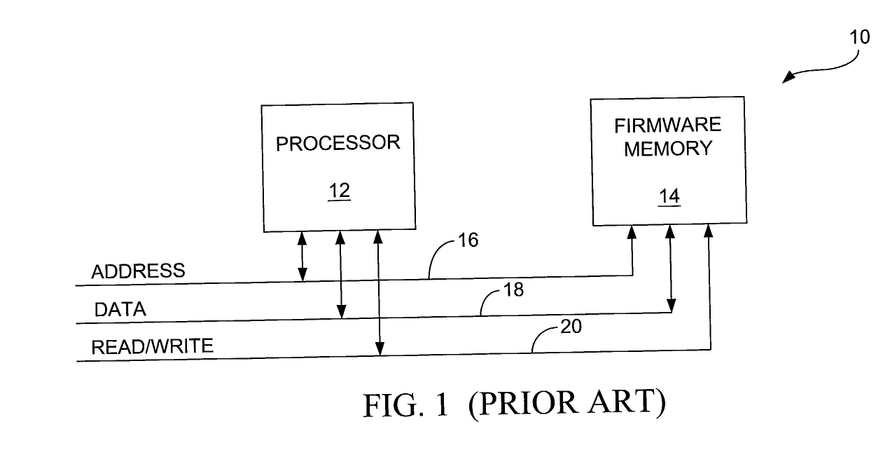

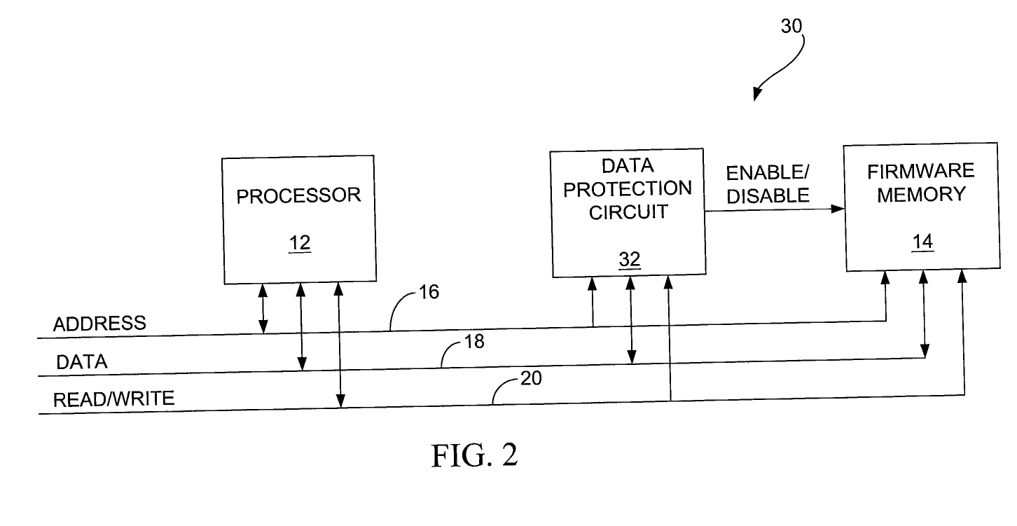

FIG. 2 is a schematic block diagram of a computer circuit 30 that includes a data-protection circuit 32 according to an embodiment of the invention, and references components common to the circuit 10 of FIG. 1 with like numbers. The computer circuit 30 is similar to the computer circuit 10 except that the data-protection circuit 32 prevents unauthorized access to the firmware stored in the memory 14, and thus can prevent an unauthorized agent from corrupting the computer system. Furthermore, because the circuit 32 is separate from, i.e., external to, the memory 14, one can implement data protection without altering the memory. Consequently, this technique allows one to protect the data stored in an off-the-shelf memory IC that has no internal data-protection circuitry.

In operation, the data-protection circuit 32 allows an authorized agent to read from and/or write to the memory 14 as long as the agent has a predetermined authorization key, but prevents an unauthorized agent from doing so as long as the unauthorized agent does not have the key.

In a first example, an authorized agent, such as a firmware-upgrade package installed by a system administrator and having the authorization key, is allowed to upgrade the firmware by writing new firmware code to the memory 14. The authorized agent initiates a write cycle by issuing a write command or commands to the processor 12. During a first write cycle, the processor 12 to asserts a write logic level on the read/write line 20, drives the address of the memory location to be written onto the bus 16, and drives the authorization key onto the data bus. The protection circuit 32 first determines whether the address on the bus 16 is a protected address. Because the address is protected, the circuit 32 next determines whether the authorization key is valid. If the circuit 32 determines that the authorization key is invalid, it disables the memory 14 such that it cannot be written to. Conversely, if the circuit 32 determines that the authorization key is valid as it does in this example, it enables the memory 14 such that it can be written to. During a second write cycle, the processor 12 maintains the write logic level on the read/write line 20 and the address of the memory location on the bus 16, and drives the upgraded firmware code onto the data bus 18. If the circuit 32 has disabled the memory 14, then code stored in the addressed memory location is not overwritten because the memory cannot not load the new firmware code from the data bus 18. But if the circuit 32 has enabled the memory 14 as it has in this example, then the memory loads the upgraded firmware code into the addressed memory location. The processor 12 continues to initiate such write cycles until it completes the desired upgrade to the firmware.

In a second example, the authorized agent having the authorization key is allowed to read the firmware in the memory 14. The authorized agent initiates a write cycle as discussed above such that the processor 12 asserts a read logic level on the read/write line 20, drives the address of the memory location to be read onto the bus 16, and drives the authorization key onto the data bus 18. The read logic level on the line 20 indicates that the authorized agent is seeking to read the addressed memory location. Because the address is protected and the authorization key is valid, the circuit 32 enables the memory 14 such that it can be read from. During a subsequent read cycle, the processor 12 maintains the read logic level on the read/write line 20 and the address of the memory location on the bus 16, and the memory 14 drives the firmware code stored in the addressed memory location onto the data bus 18. The processor 12 continues to initiate such write and read cycles until it finishes reading the desired portion of the firmware.

In a third example, an unauthorized agent, such as a virus not having the authorization key, is prevented from altering the firmware in the memory 14. The unauthorized agent initiates a write cycle by issuing a write command or commands to the processor 12. During the write cycle, the processor 12 asserts a write logic level on the read/write line 20 and drives the address of the memory location to be written onto the bus 16. Because the unauthorized agent does not have the authorization key and does not “know” that a key is required, it merely causes the processor 12 to drive the system-corrupting firmware code onto the data bus 18. Consequently, because the data on the bus 18 is an invalid authorization key, the protection circuit 32 disables the memory 14, thus preventing the unauthorized agent from altering the firmware.

In a fourth example, the unauthorized agent not having the authorization key is prevented from reading the firmware in the memory 14. The unauthorized agent initiates a read cycle by issuing a read command or commands to the processor 12. Because the unauthorized agent does not first write the authorization key to the circuit 32, the circuit disables the memory 14, thus preventing the unauthorized agent from reading the firmware.

Still referring to FIG. 2, other embodiments of the data-protection circuit 32 are contemplated. For example, although described as loading the authorization key in one cycle, the circuit 32 may load the key in two or more cycles to reduce the chance that an unauthorized agent can crack it. Furthermore, the circuit 32 may provide only read protection or only write protection, but not both. But if the circuit 32 does provide both read and write protection, it may do so merely whenever a protected address appears on the bus 16, thus eliminating the need for the circuit to receive a read/write signal. Moreover, the circuit 32 may protect memories or circuits other than a firmware memory. Furthermore, although described as being separate from the memory 14, the circuit 32 may be integrated onto the memory 14. In addition, the parameters of the read and write cycles discussed above may be as desired as long as the circuit 32 enables/disables the memory 14 based on an authorization key that is provided by the accessing agent. Such parameters include the signals that the circuit 32 receives and the timing of these signals. Moreover, the circuit 32 may protect all or some of the locations within the memory 14, and may also protect locations in other memory circuits (not shown). Furthermore, although shown as generating an enable/disable signal, the circuit 32 may selectively mask the read/write signal to disable reading or writing to the memory 14. If the computer 30 includes separate read and write lines, then the circuit 32 can disable reading, writing, or both reading and writing by selectively masking the read and/or write signals.

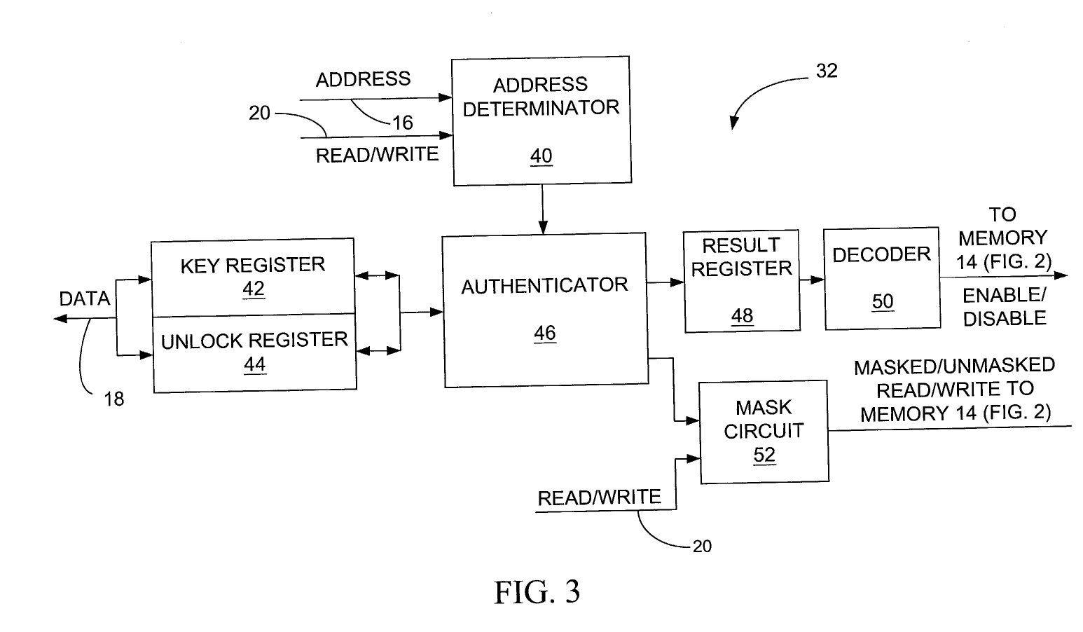

FIG. 3 is a block diagram of the data-protection circuit 32 of FIG. 2 according to an embodiment of the invention. The circuit 32 includes a determinator 40 for determining whether an address is read and/or write protected, a register 42 for storing the received authorization key, a register 44 for storing an unlock value, an authenticator 46 for determining whether the key in the register 42 is valid, a register 48 for storing a result of the algorithm executed by the authenticator 46, and a decoder 50 for decoding the result to generate the memory enable/disable signal. The circuit 32 may also include a mask circuit 52 for masking the read/write signal to the memory 14. Where the circuit 32 includes the mask circuit 52, it may omit the register 48 and decoder 50. Where there is a single read/write line 20, then the circuit 52 can disable a read or a write, but not both, to the memory 14. But if there are separate read and write lines (not shown), then the circuit 52 can disable a read, a write, or both a read and a write to the memory 14. The determinator 40 is programmed to enable the authenticator 46 when a protected address is on the bus 16 and the appropriate level of the read/write signal is on the line 20, and the register 44 is programmed or hardwired to store a predetermined unlock value. The authenticator 46 is programmed to execute an algorithm that operates on the key and unlock values respectively stored in the registers 42 and 44 and to generate a predetermined result if the key is valid. If the result is more than one bit long, the decoder 50 converts the result into a single-bit enable/disable signal that is typically coupled to an enable terminal of the memory 14.

During boot of the computer system, the circuit 32 is initialized to a state that disables the memory 14 to prevent unauthorized reading therefrom and/or writing thereto. Specifically, the contents of the register 48 are initialized to a disable value. If the circuit 32 includes the mask circuit 52, then the circuit 52 is initialized to mask the read/write signal.

In operation, the determinator 40 receives an address from the bus 16 and a read or write level from the line 20 and determines whether to activate the authenticator 46. If the address on the bus 16 is protected and the requested access (read or write) is allowed, then the determinator 40 activates the authenticator 46. If, however, the address on the bus 16 is not protected or the requested access is not allowed, the determinator 40 leaves the authenticator 46 in an inactive state such that the memory 14 remains disabled.

If the determinator 40 activates the authenticator 46, then the authenticator determines whether the authorization key on the data bus 18 is valid. The authenticator 46 loads the value on the data bus 18 into the key register 42. Next, the authenticator 46 mathematically operates on the values in the registers 42 and 44, generates a result, and loads the result into the register 48 and/or into the mask circuit 52. If the key is valid, then the result has an enable value such that the decoder 50 and/or the mask circuit 52 enables the memory 14 for the requested access (read or write). But if the key is invalid, then the decoder 50 and/or the mask circuit 52 continue to disable the memory 14. One can design the authenticator 46 to execute virtually any algorithm such as the well-known Advanced Encryption Standard (AES) algorithm on the values in the registers 42 and 44 to generate the result.

After the authenticator 46 determines that the authorization key is valid and the requested access of the memory 14 is completed, the authenticator resets the registers 42 and 48 and the mask circuit 52. By resetting the registers 42 and 48 and the circuit 52, the authenticator 46 “hides” the authentication key and re-disables the memory 14.

As discussed above in conjunction with FIG. 2, one can implement the data-protection circuit 32 and the above-described protection sequence using a variety of circuit configurations and signal timings, respectively, and can use signals other than the address, data, and read/write signals. For example, one can implement the circuit 32 in a field-programmable gate array (FPGA) or other programmable logic circuit. Such an implementation allows one to easily modify the algorithm that the authenticator 46 executes so that one can change the authentication key, the length of the result, the unlock value, and/or the decoder 50 if desired. Of course, one can design the circuit 32 with discrete logic components as well.

Still referring to FIG. 3, other embodiments of the circuit 32 are contemplated. For example, the decoder 50 may be omitted if the authenticator 46 generates a one-bit result or if the enable/disable port of the memory 14 is able to receive a signal that is more than one bit wide. Furthermore, the address determinator 40 may be uncoupled from the read/write signal, and thus may base its protected-address/unprotected-address determination on the address only.

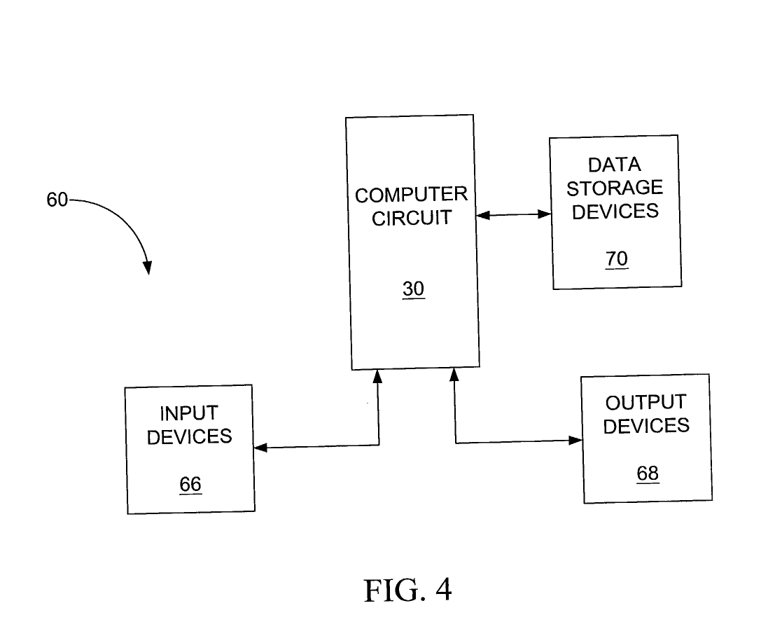

FIG. 4 is a block diagram of an electronic system 60, such as a computer system, that incorporates the computer circuit 30 of FIG. 2 according to an embodiment of the invention. The system 60 includes the computer circuitry 30 for performing computer functions, such as executing software to perform desired calculations and tasks. One or more input devices 66, such as a keyboard or a mouse, are coupled to the computer circuitry 30 and allow an operator (not shown) to manually input data thereto. One or more output devices 68 are coupled to the computer circuitry 30 to provide to the operator data generated by the computer circuitry. Examples of such output devices 68 include a printer and a video display unit. One or more data-storage devices 70 are coupled to the computer circuitry 30 to store data on or retrieve data from external storage media (not shown). Examples of the storage devices 70 and the corresponding storage media include drives that accept hard and floppy disks, tape cassettes, and compact disk read-only memories (CD-ROMs).

What is claimed:

1. A data-protection circuit for selectively allowing access to a memory location disposed in a first integrated circuit and having an address, the circuit comprising:
an authenticator operable to receive an authorization key and to allow access to the memory location if the authorization key equals a predetermined value.

2. The data-protection circuit of claim 1 wherein the authenticator is operable to:
mathematically operate on the authorization key; and
allow access to the memory location if the mathematical operation yields a predetermined result.

3. The data-protection circuit of claim 1, further comprising:
a result register; and
wherein the authenticator is coupled to the register and is operable to,
mathematically operate on the authorization key,
store a result of the mathematical operation in the register, the stored result operable to enable access to the memory location if the stored result equals a predetermined value.

4. The data-protection circuit of claim 1, further comprising:
a register for storing an unlock value; and
wherein the authenticator is coupled to the register and is operable to,
mathematically operate on the authorization key and the unlock value, and
allow access to the memory location if the mathematical operation yields a predetermined result.

5. The data-protection circuit of claim 1, further comprising:
a mask circuit; and
wherein the authenticator is coupled to the mask circuit and is operable to cause the mask circuit to allow access to the memory location if the authorization key equals the predetermined value.

6. The data-protection circuit of claim 1 wherein the authenticator is operable to disallow access to the memory location if the authorization key does not equal the predetermined value.

7. The data-protection circuit of claim 1, further comprising:
an address detector coupled to the authenticator and operable to receive an address and to determine if the received address is the address of the memory location; and
wherein the authenticator is operable to allow access to the memory location if the received address is the address of the memory location and if the authorization key equals the predetermined value.

8. The data-protection circuit of claim 1 wherein the authenticator is disposed on a second integrated circuit that is separate from the first integrated circuit.

9. A data-protection circuit for selectively disallowing access to a memory location disposed in a first integrated circuit and having an address, the circuit comprising:
an authenticator operable to receive an authorization key and to disallow access to the memory location if the authorization key does not equal a predetermined value.

10. The data-protection circuit of claim 9 wherein the authenticator is operable to:
mathematically operate on the authorization key; and
disallow access to the memory location if the mathematical operation does not yield a predetermined result.

11. The data-protection circuit of claim 9, further comprising:
a register for storing an unlock value; and
wherein the authenticator is coupled to the register and is operable to,
mathematically operate on the authorization key and the unlock value, and
disallow access to the memory location if the mathematical operation does not yield a predetermined result.

12. The data-protection circuit of claim 9, further comprising:
an address detector coupled to the authenticator and operable to receive an address and to determine if the received address is the address of the memory location; and
wherein the authenticator is operable to disallow access to the memory location if the received address is the address of the memory location and if the authorization key does not equal the predetermined value.

13. The data-protection circuit of claim 9 wherein the authenticator is disposed on a second integrated circuit that is separate from the first integrated circuit.

14. A computer circuit, comprising:
a memory circuit that includes a memory location having an address; and
a data-protection circuit coupled to the memory circuit and operable to receive an authorization key and to allow access to the memory location if the authorization key equals a predetermined value.

15. The computer circuit of claim 14, further comprising:
wherein the memory location is operable to store an instruction; and
a processor coupled to the memory circuit and operable to execute the instruction.

16. The computer circuit of claim 14 wherein:
the memory circuit is disposed in a first integrated circuit; and
the data-protection circuit is disposed in a second integrated circuit that is separate from the first integrated circuit.

17. The computer circuit of claim 14 wherein the data-protection circuit is operable to allow the writing of data to the memory location of the authorization key equals the predetermining value.

18. The computer circuit of claim 14 wherein the data-protection circuit is operable to allow reading of data from the memory location if the authorization key equals the predetermining value.

19. An electronic system, comprising:
a data input device;
a data output device; and
a computer circuit coupled to the data input and output devices and including,
a memory circuit that includes a memory location having an address, and
a data-protection circuit coupled to the memory circuit and operable to receive an authorization key and to allow access to the memory location if the authorization key equals a predetermined value.

20. A method, comprising:
receiving an authorization key; and
allowing access to the contents of a memory location if the authorization key equals a predetermined value.

21. The method of claim 20 wherein:
the receiving and allowing comprise receiving the authorization key and allowing access to the contents of the memory location with a circuit that is disposed on a first integrated circuit; and
the memory location is disposed on a second integrated circuit that is separate from the first integrated circuit.

22. The method of claim 20 wherein the allowing comprises:
mathematically operating on the authorization key and a stored unlock value; and
allowing access to the contents of the memory location if the mathematical operation yields a predetermined result.

23. The method of claim 20, further comprising:
receiving an address; and
wherein the allowing comprises allowing access to the contents of the memory location if the authorization key equals the predetermined value and if the address is the address of the memory location.
